(19) United States
(12) Patent Application Publication
(10) Pub. No.: US 2005/0078675 A1
(43) Pub. Date: Apr. 14, 2005

(54) Method and device for processing DTV data

(75) Inventors: Tomoki Nishikawa, Wakayama (JP); Kotaro Esaki, Osaka (JP)

Correspondence Address: Jack Q. Lever, Jr.;McDERMOTT, WILL & EMERY, 600 Thirteenth Street, N. W., Washington, DC, 20005-3096, US

(73) Assignee: MATSUSHITA ELECTRIC INDUSTRIAL CO., LTD.

(21) Appl. No.: 10/959,196

(22) Filed: Oct. 7, 2004

(30) Foreign Application Priority Data
Oct. 10, 2003 (JP) 2003-351590

(51) Int. Cl. H04L 12/56

(52) U.S. Cl. 370/389

(57) ABSTRACT

A data sequence of PES (packetized elementary stream) format included in received TS (transport stream) format data is recognized in a TD (transport decoder) by detecting a PES header based on a TS header and TS data. In PES mode, information indicative of the place in the data sequence where the detected PES header exists in PES data is transmitted from the TD to an AVD (AV decoder) together with the PES header. In ES mode, the detected PES header is removed in the TD, the received TS data is converted to ES format data, and the ES format data is transmitted to the AV decoder.

### CROSS-REFERENCE TO RELATED APPLICATION

This application claims priority under 35 U.S.C. §119(a) on Japanese Patent Application No. 2003-351590 filed on Oct. 10, 2003, the entire contents of the specification, drawings and claims of which are hereby incorporated by reference.

### BACKGROUND OF THE INVENTION

The present invention relates to a data processing method and data processing device used in a receiver device of digital TV (DTV) broadcast.

Conventionally, data received by a system LSI device for DTV from an antenna after preprocessing is in the form of a transport stream (TS). The DTV system is MPEG-2 system. The data sequences of MPEG-2 system include a program stream (PS) in addition to the TS, and MPEG-2 system employs a packetized elementary stream (PES) which is intermediate data in the conversion of TS and PS. These are finally converted to elementary streams (ES) before being processed. These streams, TS, PS, PES and ES, are based on established standards and have different forms from each other. In the DTV system, a TS is received by a transport decoder (TD) after being preprocessed, and divided into, for example, AV data, such as an audio signal (audio data), a video signal (video data), a text signal (teletext data), and the like, section data, such as a cipher, program information, etc. These data are transferred to an external memory and temporarily stored therein. Among these temporarily stored data, the section data are processed by software of a CPU, while the AV data are transferred from the external memory to an AV decoder (AVD) in response to a call issued by the AVD before a decoding process of the AV data is started.

Conventionally, a system LSI device incorporating a TD, an AVD and a CPU mounted on one chip has been known. In this system LSI device, an external data temporary storage memory is separately provided to each of the TD and AVD (see FIG. 1 of Japanese Unexamined Patent Publication No. 2001-69106).

Details of the processes in the AVD, for example, the expansion process of a video signal in the horizontal and vertical directions, are described in another document (see Japanese Unexamined Patent Publication No. 11-355683).

### SUMMARY OF THE INVENTION

In the above conventional technique, if information transferred through the TD to a stream interface in the AVD includes a defective packet from which some data is missing, the header of a packet next to the defective packet is illegible, and accordingly, the normal packet is discarded together with the defective packet.

This problem is now described in detail. In the conventional system, when data is transmitted from the TD to the AVD, the data is transmitted in the form of PES format data. Detection of a header which indicates the validity of the data is achieved based on the TS format in the TD but based on the PES format in the AVD. According to the PES format, the length of a packet is recorded in the header and determined, and accordingly, detection of the header is carried out for each of the lengths written in the information of the header. Thus, in a PES input in series, if the header is not detected at a position where it should be detected, a PES packet immediately previous to the position is determined to be deficient in the amount of data. Accordingly, part of the PES data which extends from the position at which the header is not detected up to the next header is abandoned. Even if the TS is processed in the AVD for the purpose of avoiding such a problem, redundant memory transfer is required. Data once stored in a memory for the TD is transferred from the TD to the AVD and stored in a memory for the AVD.

In the above-described one-chip system LSI device, it is possible to integrate the external memories separately controlled by the TD and the AVD. In such a case, however, improvement in efficiency of data transfer is an important issue. Especially, transfer of data employed in the service of transferring data during a vertical blanking interval (VBI), i.e., transfer of VBI data, is an important issue.

In order to solve the above problems, according to the present invention, a data sequence of PES format included in received TS format data is recognized in a TD by detecting a PES header based on a TS header and TS data. Information indicative of the place in the data sequence where the detected PES header exists in PES data is transmitted from the TD to an AVD together with the PES header. In another mode, the detected PES header is removed in the TD, the received TS data is converted to ES format data, and the ES format data is transmitted to the AVD.

The TD and the AVD share a data region of the temporary storage memory. The TD performs a write process in the shared data region. The AVD performs a read process from the shared data region. As for VBI data, among data stored in the temporary storage memory from the TD through the memory interface, data transfer for superposing VBI data on a video output is entirely controlled by the AVD.

According to the present invention, abandonment of valid data is prevented. At the interface between a system LSI device and an external memory, wasteful transfer can be reduced, and the capacity of the external memory can be reduced.

Furthermore, a transfer circuit of VBI data, which has conventionally been incorporated in a TD, is entirely incorporated in the AVD. With this structure, a plurality of transfer routes for VBI data are integrated, and at the same time, a data access control method is simplified.

### BRIEF DESCRIPTION OF THE DRAWINGS

FIG. 1 is a block diagram of a DTV data processing device according to embodiment 1 of the present invention.

FIG. 2 is a block diagram showing a detailed structure of a TD & AVD block of FIG. 1.

FIG. 3 conceptually illustrates use of a memory of FIG. 1.

FIG. 4 is a block diagram showing another detailed structure of the TD & AVD block of FIG. 1.

FIG. 5 is a flowchart illustrating a procedure of data processing in the structure of FIG. 4.

FIG. 6 is a time chart of a format conversion in ES mode of the structure of FIG. 4.

FIG. 7 is a time chart of a format conversion in PES mode of the structure of FIG. 4.

FIG. 8 is a block diagram showing a variation of the structure of FIG. 4.

FIG. 9 is a block diagram of a DTV data processing device according to embodiment 2 of the present invention.

FIG. 10 is a block diagram showing a detailed structure of a video output circuit of FIG. 9.

FIG. 11 is a block diagram showing another detailed structure of the video output circuit of FIG. 9.

FIG. 12 is a block diagram showing still another detailed structure of the video output circuit of FIG. 9.

FIG. 13 is a block diagram showing a variation of the structure of FIG. 9.

### DESCRIPTION OF THE PREFERRED EMBODIMENTS

Hereinafter, embodiments of the present invention are described with reference to the drawings.

### Embodiment 1

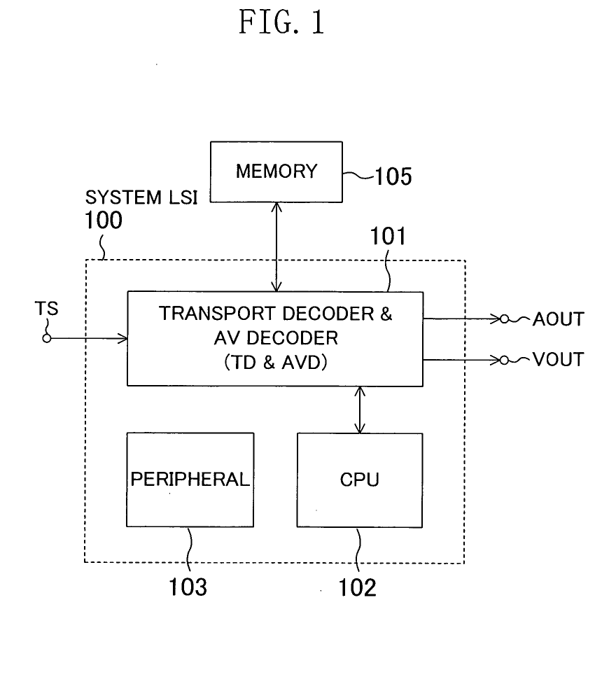

FIG. 1 shows an exemplary general structure of a DTV data processing device according to embodiment 1 of the present invention. Referring to FIG. 1, in a system LSI device 100 for DTV, “TS” is a data input which is received by an antenna and subjected to preprocessing, and “AOUT” and “VOUT” are an AV-decoded audio output and an AV-decoded video output, respectively. Reference numeral 101 denotes a block (TD & AVD block) into which the systems of the TD (transport decoder) and AVD (AV decoder) are integrated. Reference numeral 102 denotes a CPU. Reference numeral 103 denotes a peripheral, such as a timer, a serial communication, or the like. Reference numeral 105 denotes a memory external to the system LSI device 100.

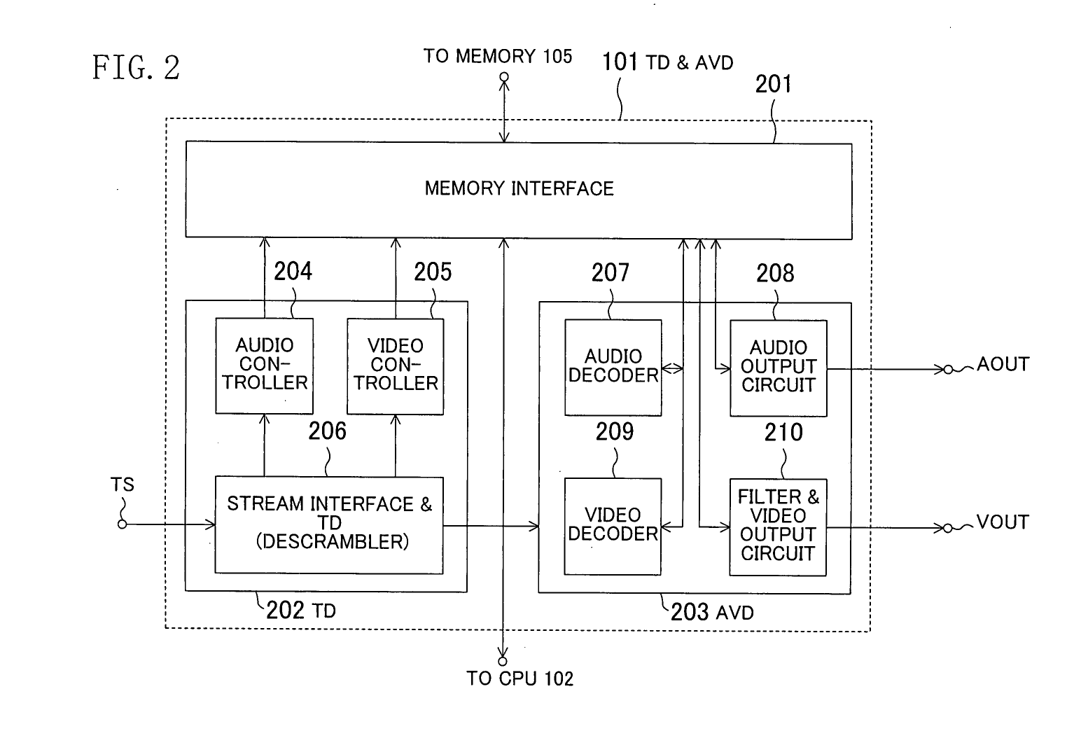

FIG. 2 shows an exemplary detailed structure of the TD & AVD block 101 of FIG. 1. In FIG. 2, reference numeral 201 denotes a memory interface. Reference numeral 202 denotes a TD. Reference numeral 203 denotes an AVD. Reference numeral 204 denotes an audio controller. Reference numeral 205 denotes a video controller. Reference numeral 206 denotes a block including a conventional TD and a stream interface integrated thereto. Reference numeral 207 denotes an audio decoder. Reference numeral 208 denotes an audio output circuit. Reference numeral 209 denotes a video decoder. Reference numeral 210 denotes a filter & audio output circuit.

The DTV data processing device of embodiment 1 includes a stream interface & TD block 206 and the controllers 204 and 205 respectively for video and audio. With this structure, data converted from TS to PES is sent to the AVD 203, while data in the ES format is also sent to the AVD 203. Further, after the TD 202 of embodiment 1 temporarily stores data in an external memory 105 through the memory interface 201, even when the AVD 203 asks to receive the temporarily stored data, the temporarily stored data is directly sent from the external memory 105 to the AVD 203 without passing through the TD 202.

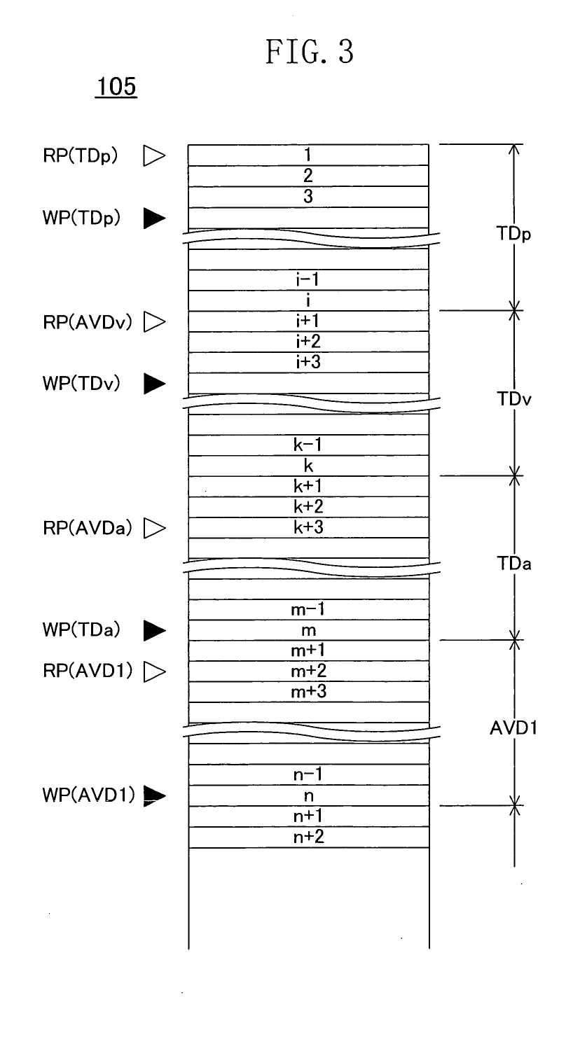

FIG. 3 illustrates use of the memory 105 of FIG. 1. In FIG. 3, “TDp” denotes an exclusive region for the TD 202; “TDv” and “TDa” denote common regions for transmitting data from the TD 202 to the AVD 203; and “AVD1” denotes an exclusive region for the AVD 203. Referring to FIG. 3, in the common regions, write pointers associated with data written by the TD 202 (WP for video (TDv) and WP for audio (TDa)) are managed by the TD 202, whereas read pointers (RP for video (TDv) and RP for audio (TDa)) are managed by the AVD 203. These pointers are read from software through the CPU 102 and managed. However, if the received data is data different from AV data, e.g., a section, or the like, write pointer WP (TDp) and read pointer RP (TDp) are managed by the TD 202. As for the exclusive region for the AVD 203, write pointer WP (AVD1) and read pointer RP (AVD1) are managed by the AVD 203.

As described above, the memory regions used by the TD 202 and the AVD 203 are integrated, and redundant data transfer is reduced. Thus, the power consumption is reduced, and the transfer efficiency of the system is improved. Further, since the TD 202 and the AVD 203 are integrated, a redundant circuit is omitted, and the circuit area is decreased.

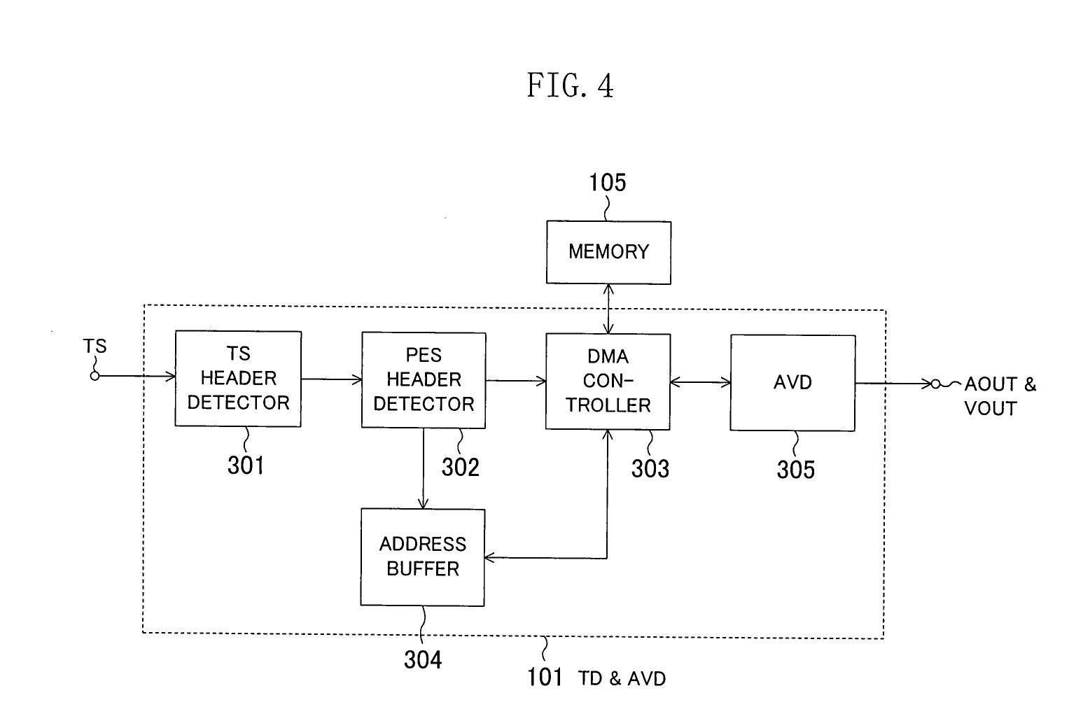

FIG. 4 shows another exemplary detailed structure of the TD & AVD block 101 of FIG. 1. In FIG. 4, reference numeral 301 denotes a block for detecting a header of a TS (TS header detector); and reference numeral 302 denotes a block for detecting a header of a PES based on the TS header obtained from the TS header detector 301 (PES header detector). The TS header detector 301 can remove only the data of headers from a PES data sequence depending on the settings. Reference numeral 303 denotes a DMA controller for controlling an access to the memory 105. Reference numeral 304 denotes an address buffer for storing address information of a PES header stored in the memory 105. Reference numeral 305 denotes an AVD.

In the structure of FIG. 4, the TD (TD & AVD block 101) includes a PES header detector 302 for detecting the head of a header of a PES in an input data stream (input data) which is in the form of a TS using the TS header and data obtained from the TS header detector 301. Data corresponding to the PES header is removed according to the information indicative of the head of the header which has been detected by the TS header detector 301, whereby the input data is converted to the ES format before being sent to the AVD 305. When the PES header is transmitted, information indicative of which address the PES header is to be stored in is stored in the address buffer 304, so that the AVD 305 can recognize the PES header. With such a mechanism, the AVD 305 can remove the PES header with no consideration of the length information represented by the PES header. Thus, valid data is efficiently transferred without being abandoned. Thus, unnecessary abandonment of data is prevented.

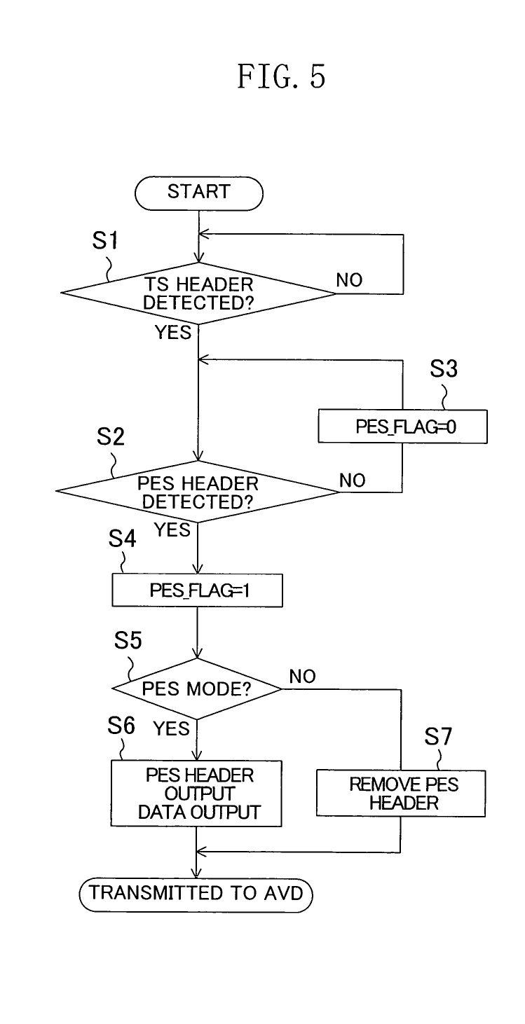

FIG. 5 is a flowchart illustrating a procedure of data processing in the structure of FIG. 4. The process is performed on the input TS data according to the steps S1 to S7 of the flow shown in FIG. 5, whereby the position where the PES header resides is detected in the TS data. In the PES mode wherein data is transmitted to the AVD 305 in the form of PES format data, information indicative of which address of the memory 105 the data is to be stored in (address information) is simultaneously acquired, and the address information is transmitted to the AVD 305. In the AVD 305, the PES header is processed based on this address information, and therefore, valid data is obtained. In the ES mode wherein data is transmitted to the AVD 305 in the form of ES format data, a PES header is abandoned in advance in the TD based on detected information, whereby only the ES data is stored in the memory 105.

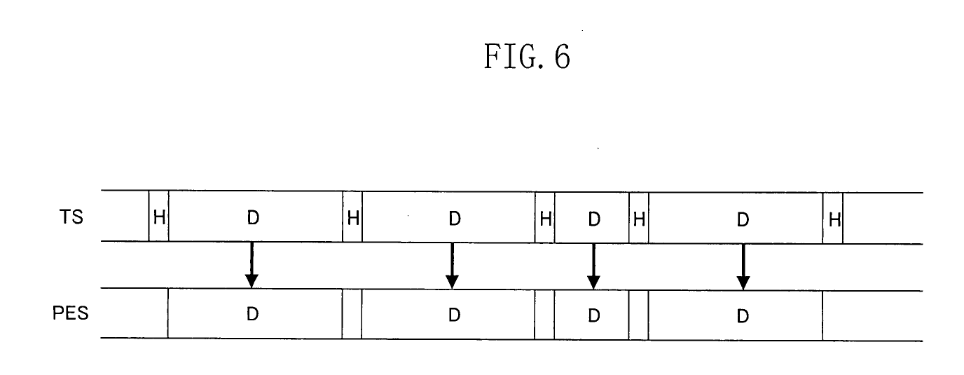

FIG. 6 illustrates a format conversion in the ES mode in the structure of FIG. 4, where “H” denotes a header, and “D” denotes data. In FIG. 6, a TS is converted to a PES with no wastage. This applies to conversion from a PES to an ES. Thus, detection of a header is not necessary in the AVD 305, and the process is advanced smoothly. Therefore, no valid data is abandoned.

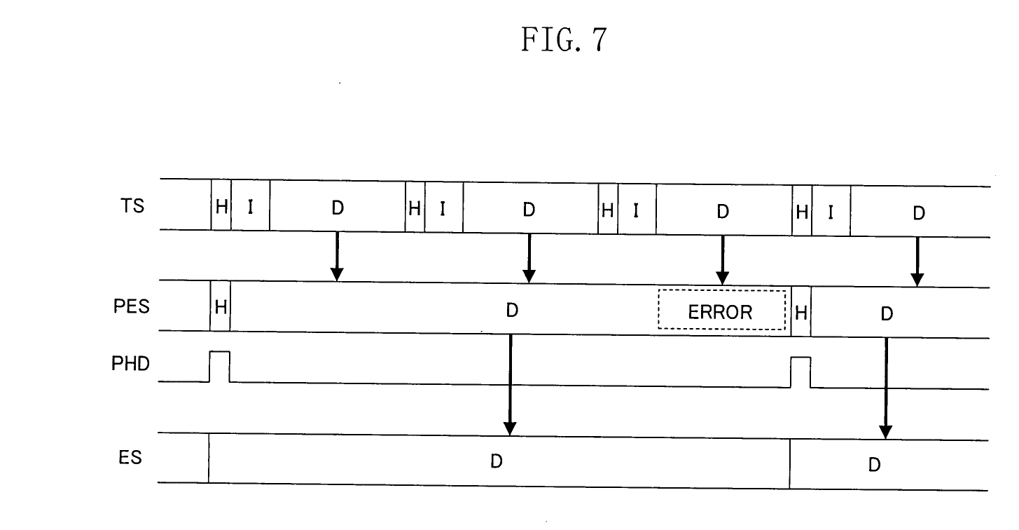

FIG. 7 illustrates a format conversion in the PES mode in the structure of FIG. 4, where “H” denotes a header, “I” denotes an ID, and “D” denotes data. When a PES header is detected in the method illustrated in FIG. 5, pulse signal PHD which indicates the head of the PES header is generated as shown in FIG. 7, and the PES header is deleted based on pulse signal PHD. Alternatively, pulse signal PHD and the leading data of the PES header are sent to the AVD 305 at the same time. In the AVD 305, the length included in the information contained in the PES header is not monitored for detecting the next PES header, but pulse signal PHD indicative of the head of the PES header is used for recognizing the PES header. With this structure, even if there is PES data which lacks in the amount of data as compared with the length of a PES, the next PES header can correctly be detected, and therefore, no valid data is abandoned. As a result, data is secured, and the data quality is improved.

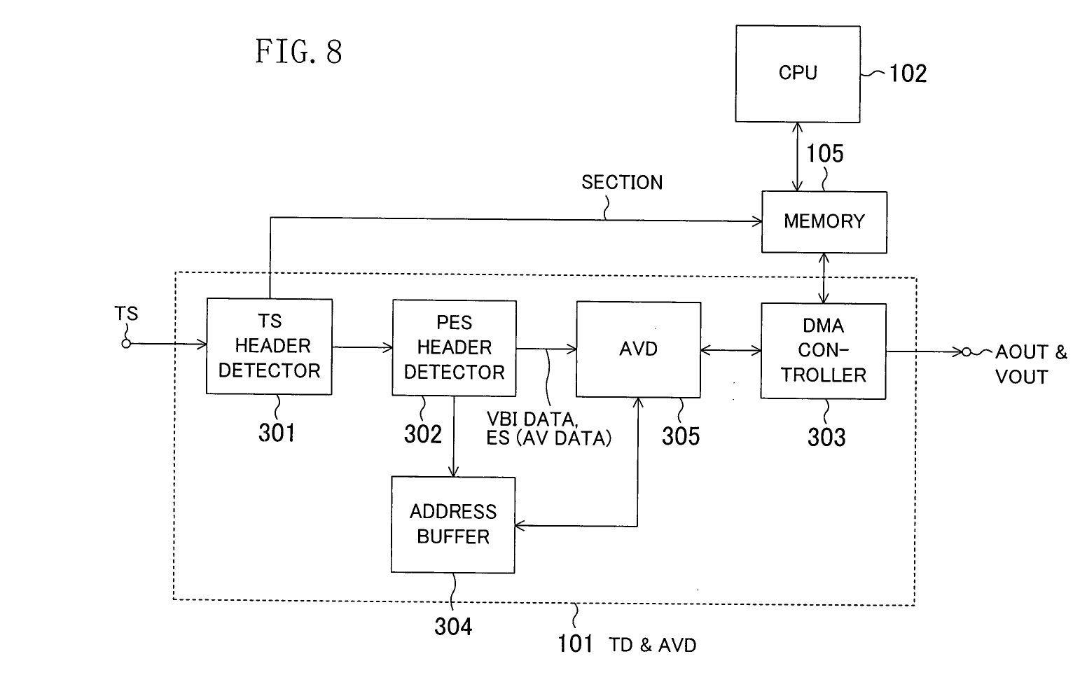

FIG. 8 shows a variation of the structure of FIG. 4. In the example of FIG. 8, AV data is converted to an ES in the TD and sent to the AVD 305. All of the data is managed by the AVD 305. Alternatively, the area of the memory 105 is shared among the TD and the AVD 305. Section data is subjected to filtering and then sent not to the AVD 305 but to the CPU 102. VBI data (text data) is subjected to filtering and format conversion and then sent to the AVD 305.

### Embodiment 2

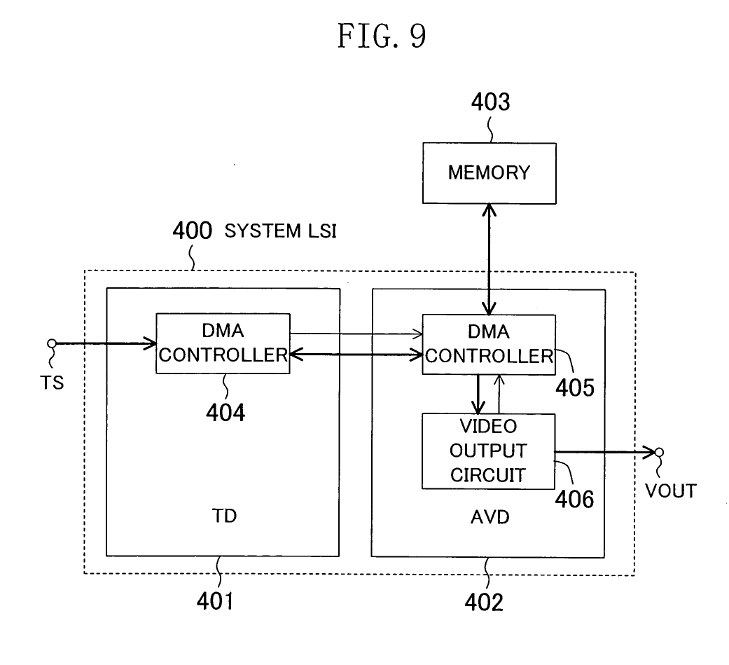

FIG. 9 show an exemplary general structure of a DTV data processing device according to embodiment 2 of the present invention. In FIG. 9, reference numeral 400 denotes a system LSI device; reference numeral 401 denotes a TD; reference numeral 402 denotes an AVD; reference numeral 403 denotes an external memory; reference numeral 404 denotes a DMA controller of the TD 401; reference numeral 405 denotes a DMA controller of the AVD 402; and reference numeral 406 denotes a video output circuit.

When a TS is input to the system LSI device 400 of FIG. 9, the TD 401 separates this input stream into video data, audio data, and other broadcast data, and temporarily saves these separated data in the external memory 403 through the AVD 402. At this point in time, the DMA controller 404 of the TD 401 issues to the DMA controller 405 of the AVD 402 a request signal for writing data in the memory 403. The DMA controller 405 of the AVD 402 arbitrates among all of the access requests to the memory 403 and thereafter gives the TD 401 a permission to write data in the memory 403 at an appropriate timing. The data temporarily saved in the memory 403 in this way is retained therein till a read request is issued by any of circuit blocks which subject the data to various processing.

Among the thus-stored video data, audio data and other broadcast data, VBI data output during a vertical blanking interval in video display, represented by teletext data, is superposed on a scanning line at an appropriate timing by the video output circuit 406 incorporated in the AVD 402. In the meantime, the video output circuit 406 issues a request signal for reading data from the memory 403 to the DMA controller 405 incorporated in the AVD 402. Receiving this request signal, the DMA controller 405 arbitrates among all of the data access requests to the memory 403 and then, at an appropriate timing, gives the video output circuit 406 a permission to read data. Then, the video output circuit 406 reads the VBI data from the memory 403. In this way, the AVD 402 processes a video signal including VBI data in the video output circuit 406 according to a corresponding broadcast standard and outputs the processed signal through terminal VOUT.

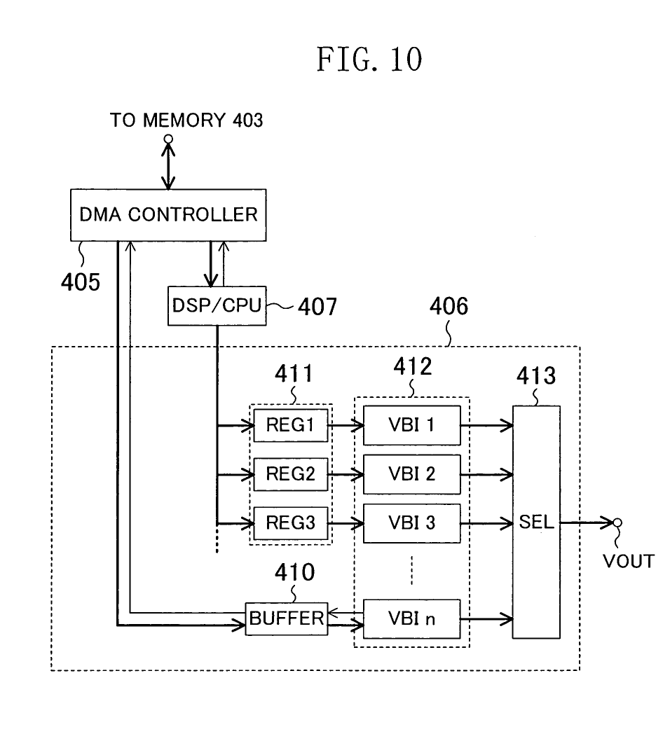

FIG. 10 shows an exemplary detailed structure of the video output circuit 406 of FIG. 9. In FIG. 10, reference numeral 407 denotes a DSP or CPU; reference numeral 410 denotes a buffer memory for VBI data; reference numeral 411 denotes a group of registers; reference numeral 412 denotes a VBI pulse generation circuit; and reference numeral 413 denotes a selector (SEL) for VBI superposition.

The video output circuit 406 of FIG. 10 incorporates the VBI pulse generation circuit 412 which generates a pulse according to various standards of the VBI data output system. The VBI pulse generation circuit 412 includes n generation circuits VBI1 to VBIn, the number of which corresponds to the number of various VBI standards. In a vertical blanking interval, when the VBI pulse generation circuit 412 corresponds to a standard in which the total amount of data to be superposed is relatively small (e.g., closed caption), the data to be superposed is once written in the internal registers 411 by software processing. When the VBI pulse generation circuit 412 detects a timing at which the data is superposed, the data written in the internal registers 411 is read and serial-converted. The converted data is output as VBI data. In the meantime, the CPU (or DSP) 407, which controls the video output circuit 406, writes the data read from the memory 403 through the DMA controller 405 in the group of registers 411 in which the VBI data is written.

On the other hand, in a vertical blanking interval, when the VBI pulse generation circuit 412 corresponds to a standard in which the total amount of data to be superposed is relatively large (e.g., teletext), the VBI pulse generation circuit 412 issues in advance a request signal for reading VBI data from the memory 403 to the DMA controller 405 in the vertical blanking period. The DMA controller 405 arbitrates among all of the access requests to the memory 403 according to the request signal, and thereafter, the VBI data read from the memory 403 is transferred to the buffer memory 410 at an appropriate timing. Then, the VBI data is read from the buffer memory 410 in synchronization with the timing of pulse generation. The VBI data is serial-converted before being output.

Among the pulses output from the VBI pulse generation circuit 412 as described above, a pulse of a VBI standard having the highest priority on a scanning line number (on the line) of the video signal with which the VBI pulse has been generated is solely selected by the VBI superposition selector 413 and is thereafter superposed as VBI data on an actual video signal in the vertical blanking period according to the timing of the selected pulse before being output through terminal VOUT.

By repeating the above-described series of operations, all of the VBI data are saved in the memory 403 and thereafter controlled only by the DMA controller 405 of the AVD 402 without passing through the TD 401. Thus, the systems are integrated, so that wasteful arbitration for data accesses between the system LSI device 400 and the memory 403 is unnecessary. As a result, a system breakdown is prevented. Especially, as for transfer of the VBI data, the output of the VBI data is necessary during a vertical blanking interval of a video signal, i.e., during a time period when transfer of the VBI data is not necessary, and therefore, in the video output circuit 406, a request of data transfer to the DMA controller 405 can be issued by a single operation in conjunction with the video signal data. Further, the arbitration circuit is simplified, and accordingly, the device area is reduced.

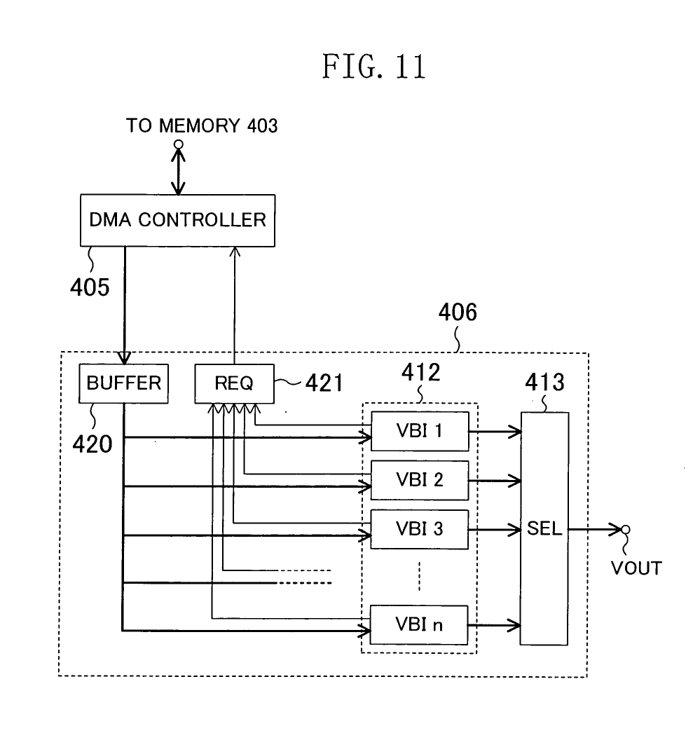

FIG. 11 shows another exemplary detailed structure of the video output circuit 406 of FIG. 9, where reference numeral 420 denotes a buffer memory for storing VBI data; and reference numeral 421 denotes a request detection circuit. In the example of FIG. 11, a data read request signal is directly issued to the DMA controller 405 incorporated in the AVD 402 from any of the generation circuits (VBI1 to VBIn) of the VBI pulse generation circuit 412 which generates a pulse according to various VBI standards. Various VBI data stored in the memory 403 is transferred in advance to the buffer memory 420 through the DMA controller 405 according to the VBI data read request. The VBI pulse generation circuit 412 reads VBI data from the buffer memory 420 along with pulse generation and subjects the VBI data to serial conversion.

In the structure of FIG. 11, any of the generation circuits (VBI1 to VBIn) of the VBI pulse generation circuit 412 completes data transfer with no software control by the CPU or DSP regardless of the VBI standard. Thus, software development can be simplified. Further, the buffer memory 420 for storing VBI data is shared so that redundant registers can be eliminated. Therefore, the area of the system LSI device 400 is reduced.

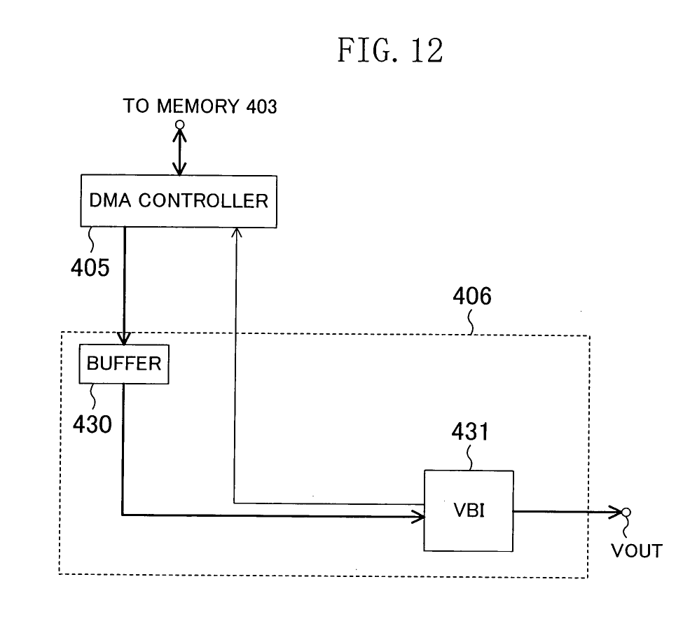

FIG. 12 shows still another exemplary detailed structure of the video output circuit 406 of FIG. 9, where reference numeral 430 denotes a buffer memory for storing VBI data; and reference numeral 431 denotes a programmable VBI pulse generation circuit. In the example of FIG. 12, with appropriate register settings, a data read request signal is directly issued to the DMA controller 405 incorporated in the AVD 402 from the VBI pulse generation circuit 431 which can generate a pulse according to various VBI standards. Various VBI data stored in the memory 403 is transferred in advance to the buffer memory 430 from the DMA controller 405 according to the VBI data read request. The VBI pulse generation circuit 431 reads VBI data from the buffer memory 430 along with pulse generation and subjects the VBI data to serial conversion.

In the structure of FIG. 12, the system flexibility is improved by employing the programmable VBI pulse generation circuit 431.

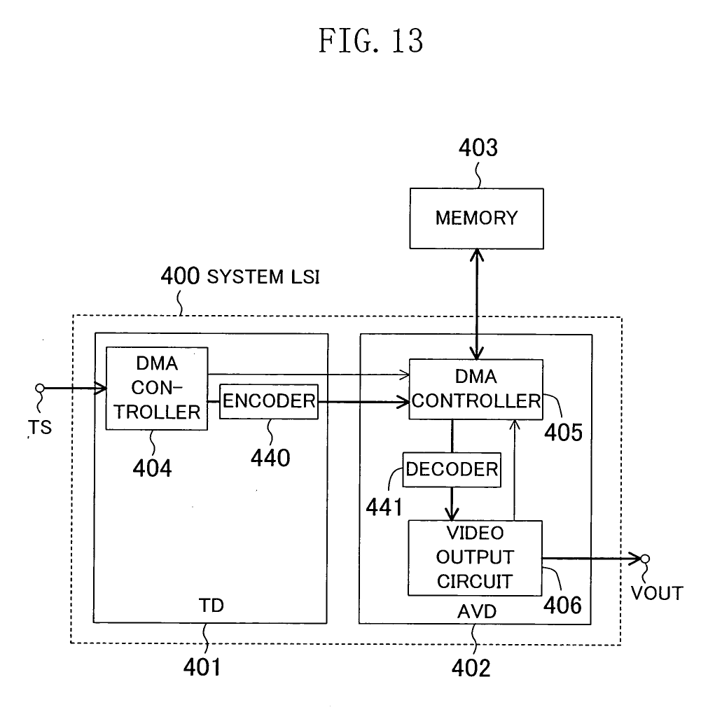

FIG. 13 shows a variation of the structure of FIG. 9, where reference numeral 440 denotes an encoder; and reference numeral 441 denotes a decoder. In the structure of FIG. 13, among the data temporarily saved in the memory 403, VBI data output during a vertical blanking interval in video display, represented by teletext data, is compressed by the encoder 440 incorporated in the TD 401. The thus-compressed VBI data is read by the video output circuit 406 incorporated in the AVD 402 at an appropriate timing and superposed on a scanning line. In the meantime, the video output circuit 406 issues a request signal for reading data from the memory 403 to the DMA controller 405 incorporated in the AVD 402. Receiving this request signal, the DMA controller 405 arbitrates among all of the data access requests to the memory 403 and then, at an appropriate timing, gives the video output circuit 406 a permission to read data. Then, the video output circuit 406 reads the VBI data from the memory 403. Since the VBI data read through the DMA controller 405 is compressed data, the VBI data is decompressed to original data by the decoder 441 incorporated in the AVD 402. The video output circuit 406 processes the decompressed VBI data according to a corresponding broadcast standard and outputs the processed VBI data through terminal VOUT.

By repeating the above-described series of operations, all of the VBI data are compressed by the encoder 440 and then temporarily saved in the memory 403. Thereafter, when the VBI data are read again from the AVD 402, the read VBI data is decompressed to original data by the decoder 441 after passing through the DMA controller 405. Thus, the amount of data transferred between the system LSI device 400 and the memory 403 is reduced.

As described above, the present invention is useful for data processing in a DTV receiver device, or the like.

1. A data processing method used in a DTV data processing device which includes a transport decoder and an AV decoder, comprising the steps of:
in the transport decoder, recognizing a data sequence of packetized elementary stream (PES) format which is included in received transport stream (TS) format data by detecting a PES header based on a TS header and TS data;
in one mode, transmitting information indicative of the place in the data sequence where the detected PES header exists in the PES data together with the PES header from the transport decoder to the AV decoder; and
in another mode, removing the detected PES header in the transport decoder, converting the received TS data to elementary stream (ES) format data, and transmitting the ES format data to the AV decoder.

2. A DTV data processing device comprising a transport decoder, an AV decoder, and a memory interface to which a temporary storage memory is connected,
wherein the transport decoder and the AV decoder share a data region of the temporary storage memory,
the transport decoder performs a write process in the shared data region, and
the AV decoder performs a read process from the shared data region.

3. The DTV data processing device of claim 2, further comprising a CPU for system control,
wherein when a data write operation is performed on the memory interface by the transport decoder, a write pointer indicative of a memory region where a data sequence is written is recognized by the AV decoder through the CPU.

4. The DTV data processing device of claim 3, wherein when a data read operation from the AV decoder to the memory interface is performed, a read pointer indicative of a memory region where a previously-read data sequence has been stored is recognized by the transport decoder through the CPU.

5. A DTV data processing device comprising a transport decoder and an AV decoder,
wherein the transport decoder has a mechanism for converting data which is input in the form of a transport stream (TS) format data to elementary stream (ES) format data, and
the transport decoder transmits the ES format data to the AV decoder.

6. The DTV data processing device of claim 5, wherein:
the transport decoder includes
a PES header detection mechanism for detecting a packetized elementary stream (PES) header based on a TS header included in received TS data, and
a mechanism for removing the PES header based on the detected PES header irrespective of length information of PES data which is included in the PES header; and
data which is input to the transport decoder in the form of TS format data is converted to ES format data and transmitted to the AV decoder.

7. The DTV data processing device of claim 6, wherein:
the transport decoder further includes
a mechanism for converting input data which is received in the form of TS format data to PES data, and
a mechanism for transmitting information obtained from the PES header detection mechanism to the AV decoder together with the PES data; and
the AV decoder receives information which represents the PES header, thereby detecting a PES header irrespective of information of PES data which is included in the PES header.

8. A DTV data processing device comprising a transport decoder, an AV decoder, and a memory interface to which a temporary storage memory is connected,
wherein among data stored in the temporary storage memory from the transport decoder through the memory interface, data transfer for superposing vertical blanking interval (VBI) data on a scanning line output is entirely controlled by the AV decoder.

9. The DTV data processing device of claim 8, separately comprising a circuit for generating a pulse according to a standard of a data broadcast which is superposed during a vertical blanking interval,
wherein a data transfer route is changed according to the total amount of VBI data superposed during the vertical blanking interval.

10. The DTV data processing device of claim 8, separately comprising a circuit for generating a pulse according to a standard of a data broadcast which is superposed during a vertical blanking interval,
wherein a data transfer route is only one irrespective of the total amount of VBI data superposed during the vertical blanking interval, and
the DTV data processing device further includes a buffer for storing VBI data which is to be superposed on the data transfer route.

11. The DTV data processing device of claim 8, comprising only one circuit for generating a pulse irrespective of a standard of a data broadcast which is superposed during a vertical blanking interval,
wherein a data transfer route is only one irrespective of the total amount of VBI data superposed during the vertical blanking interval, and
the DTV data processing device further includes a buffer for storing VBI data which is to be superposed on the data transfer route.

12. The DTV data processing device of claim 8, wherein:
in the process of writing VBI data in the temporary storage memory, the data is compressed according to a predetermined format; and
in the process of reading the data from the temporary storage memory, the compressed data is decompressed according to the predetermined format.
